(19) United States
(12) Patent Application Publication
(10) Pub. No.: US 2003/0222925 A1
(43) Pub. Date: Dec. 4, 2003

(54) Field control method and system

(75) Inventor: Stephen J. Regelous, Wellington (NZ)

Correspondence Address: PILLSBURY WINTHROP, LLP, P.O. BOX 10500, MCLEAN, VA, 22102, US

(73) Assignees: Stephen John Regelous, Wellington (NZ); Stephen Noel Regelous, Auckland (NZ)

(21) Appl. No.: 10/446,804

(22) Filed: May 29, 2003

(30) Foreign Application Priority Data
May 31, 2002 (NZ) 519321

(51) Int. Cl. G09G 5/00

(52) U.S. Cl. 345/856

(57) ABSTRACT

The present invention relates to a field control method and system. More particularly the present invention relates to a method for changing the values of a field by use of a virtual slider. A value from a field is displayed on a display device (12). A digit of the value is selected in response to user input from a pointer device (13). The value is changed by the magnitude of the selected digit in response to user input from a pointer device (14). The invention may find particular application in graphical user interface systems. A field control user interface system is disclosed. A method and user interface system for controlling a field and one or more associated fields is also disclosed.

### FIELD OF INVENTION

The present invention relates to a field control method and system. More particularly, but not exclusively, the present invention relates to a method and user interface system for changing the values of a field by use of a virtual slider.

### BACKGROUND TO THE INVENTION

Software programs exist which have user interface elements that enable the user to change the values of a field.

Present solutions to change the values of a field include the user entering in the new value manually by typing a string of characters from a keyboard or using a software mechanism called a slider.

There are visual sliders which can be represented on a display by a bar, optionally with buttons at each end marked with arrows and a smaller bar visible between the ends of the first bar whose position relative to the first bar gives an approximate indication of the value of the field.

There are also virtual sliders. A simple virtual slider works by a user moving a pointer by the use of a mouse or other device over the field to be adjusted and clicking a button, such as a mouse button, and moving the pointer to the left while the button is depressed (dragging the pointer) to decrement the value of the field or the right to increment the value. One known implementation of a virtual slider enables a user to define the magnitude of change by pressing specific keys on a keyboard. Another known implementation utilizes variation in the Y axis of mouse movement (or Y axis positions relative to the field) to change magnitude and decrement or increment the value of the field relative to mouse motion in the X axis according to the magnitude.

These approaches have the following difficulties:

The keyboard modified virtual slider method introduces another input device, thereby complicating the process and requiring the use of two hands to operate.

The Y axis virtual slider method requires precise movement of the mouse as small Y axis movements and small X axis movements can result in large value changes.

The Y axis virtual slider requires motion in 2 axes to affect a single value.

The Y axis virtual slider has fixed ranges of magnitude which, depending on the implementation, may not correspond to the magnitude of the value to be edited.

The magnitude defined by both methods is either unknown by the user or requires an additional interface element to display.

It is an object of the present invention to provide a field control method and system which enables a user to change values within a field by use of a virtual slider and overcomes the above difficulties.

### PREFERRED EMBODIMENTS OF THE INVENTION

According to a first aspect of the invention there is provided a method of controlling a field, the method including the steps of:

i. displaying a value from the field on a display device;

ii. selecting a digit of the value displayed in response to user input from a pointer device; and

iii. changing the value by the magnitude of the selected digit in response to user input from a pointer device.

The pointer device is a user input device for controlling the pointer within a graphical user interface. The pointer device may be a mouse, a scroll wheel mouse, a trackball, a joystick or stylus and graphics tablet.

The digit may be selected by using the pointer device to position a pointer over the digit and pressing and holding down a button, such as a mouse button, or by pressing and releasing a button. The digit may be selected by using the pointer device to press and hold down a button and dragging the pointer over the digit.

The magnitude of the selected digit is the position of the digit within the value. If the digit is the third digit to the left of the decimal point within a base-10 value then the digit has the magnitude of 100 (10²). If the digit is the third digit to the left of the decimal point within a base-16 value represented using the following digits: 0, 1, 2, 3, 4, 5, 6, 7, 8, 9, A, B, C, D, E, F; then the selected digit has a magnitude of 256 (16²).

If the value within a field is changed by the magnitude of the selected digit then the value is increased or decreased by the amount of the magnitude. Therefore if the magnitude of the selected digit is 100, the value will be increased by the amount 100 or decreased by the amount 100 for each increment or decrement of the pointer position along an axis.

Movement of the pointer device by the user may change the value by the magnitude of the selected digit.

Movement of the pointer device to the left may decrease the value by the magnitude of the selected digit.

Movement of the pointer device to the right may increase the value by the magnitude of the selected digit.

The value may be changed in multiples of the magnitude in proportion to the displacement of the pointer device.

The selected digit may be signified on the display device by highlighting the digit.

According to a further aspect of the invention there is provided a method of controlling a first field and any number of associated fields, the method including the steps of:

i. displaying the value of the first field and values of the associated fields;

ii. selecting a digit of the value of the first field in response to user input from a pointer device; and

iii. changing the value of the first field and values of the associated fields by the magnitude of the digit selected in response to user input from a pointer device.

Fields may be defined as associated with each other by the software application using the method.

The value of first field may be changed by movement of the pointer device along one axis and the value of an associated field may be changed by movement of the pointer device along a different axis.

Further associated fields may be changed by movement of the pointer device along different axes. For example, the pointer device may be a mouse with a scroll wheel, in which case the scroll wheel adds a third axis of movement.

According to a further aspect of the invention there is provided a user interface system for controlling a field, the system comprising:

i. a processor for changing a value in response to movement of a user input device;

ii. memory for storing the value;

iii. a user input device to select a digit of the value and to provide feedback to the processor to change to value; and

iv. an output device for displaying the value.

The user input device may be a mouse or a similar device which can control a pointer within a graphical user interface such as a scroll wheel mouse, a joystick or a track-ball or a stylus and graphics tablet.

According to a further aspect of the invention there is provided a user interface system for controlling a first field and any number of associated fields, the system comprising:

i. a processor for changing the value of the first field and values of the associated fields in response to movement of a user input device;

ii. memory for storing the values of the first and associated fields;

iii. a user input device to select a digit of the value of the first field and to provide feedback to the processor to change the values of the first and associated fields; and

iv. an output device for displaying values of the first and associated fields.

### BRIEF DESCRIPTION OF THE DRAWINGS

The invention will now be described by way of example with reference to the accompanying drawings in which:

FIG. 1: shows a state transition diagram illustrating the method.

FIG. 2: shows a visual representation of an example of one implementation of the method for controlling a field.

FIG. 3: shows a visual representation of an example of one implementation of the method for controlling a first field and an associated second field.

FIG. 4: shows a visual representation of an example of one implementation of the method for controlling a first field and two associated fields.

### DETAILED DESCRIPTION OF PREFERRED EMBODIMENTS

The present invention relates to a method and a system for providing a user interface to enable the changing of a value within a field. The method involves the selection of a digit of the value and changing the value by integer steps of the magnitude of the digit.

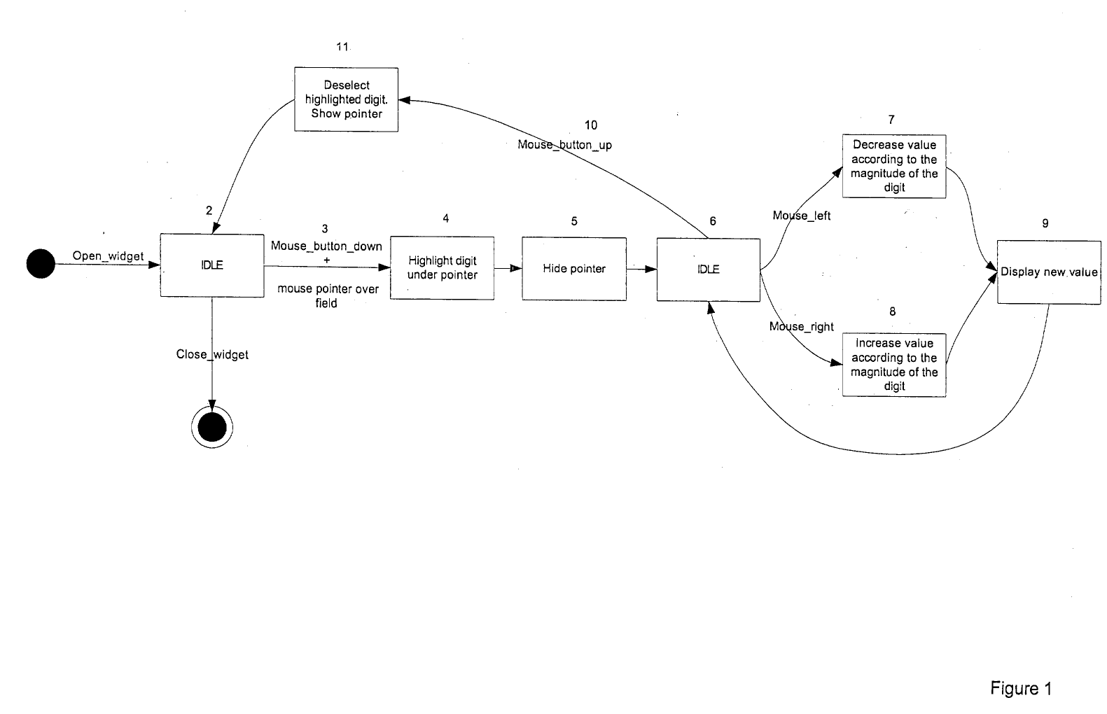

Referring to FIG. 1, the method may be implemented as a widget. A widget is a software module within an application that provides an element for the graphical user interface such as displaying information or providing a specific way for a user to interact with the application.

The application which is using the widget will open the widget in step 1 in relation to a specific field. The widget will wait in step 2 until a user presses a mouse button when the pointer is over the field in step 3. The user may be using another device such as a trackball or a joystick.

The widget will determine which digit of the value the pointer is over and select that digit in step 4. In another implementation of the method the widget may select the digit by the user clicking and dragging the pointer.

In step 5 the widget will highlight the digit selected.

The widget then hides the on-screen pointer from the user in step 6. Other implementations may leave the pointer on-screen.

The widget waits until movement from the mouse is detected. If the mouse is moved left the value is decreased in step 7 by the magnitude of the selected digit. If the mouse is moved right the value is increased in step 8 by the magnitude of the selected digit. Other axes may be used and the orientation may be reversed.

Once the value has been changed the new value will be displayed in step 9 and the widget waits at step 6 for further movement. Each increment or decrement may correspond to a given displacement of the mouse so that the amount incremented or decremented is proportional to movement of the mouse. If the mouse button initially pressed is released in step 10 the widget will unselect the digit, redisplay the pointer and return to wait at step 2 until another digit is selected.

Other implementations of the method may select the digit by clicking—pressing and releasing—the mouse button in which case the digit may be unselected by clicking the button again.

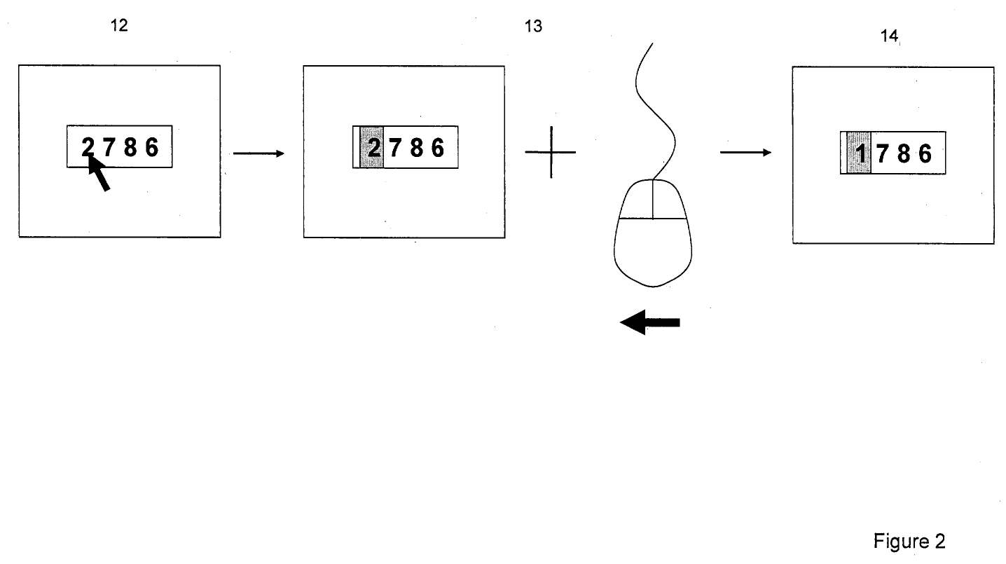

FIG. 2 shows an example of one possible implementation of the method for controlling a field.

In the first step 12 the pointer is over the field and over the “2” digit within the value. In the second step 13 the “2” digit has been selected. This may have occurred by the pressing and holding down of a mouse button, by clicking a mouse button or by some other user action. The “2” digit has been highlighted as the selected digit by backlighting the digit in a different shade. The user now moves the mouse to the left by one increment.

The third step 14 shows the value as it has been changed. The digit “2” within the value “2786” has a magnitude of 1000. The original value, “2786”, has been changed by 1000. In this example, the mouse moving left decreases the value. The new value is “1786”. Movement of the mouse to the left by another increment will decrease the value to “786”.

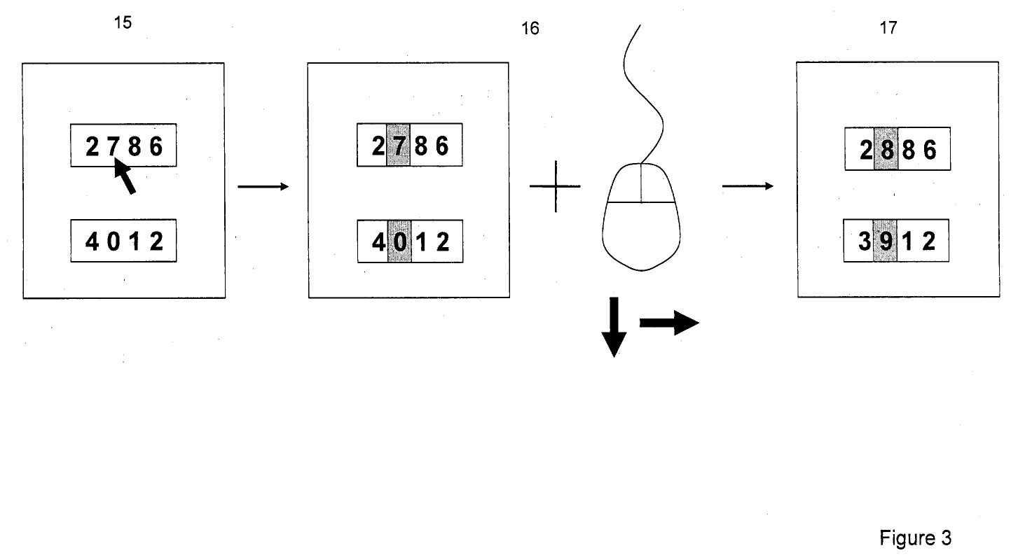

FIG. 3 shows an example of one possible implementation of the method for controlling a first field and an associated second field.

In the first step 15 the pointer is over the first field and over the “7” digit within the value. In the second step 16 the “7” digit within the first field has been selected. This may have occurred by the pressing and holding down of a mouse button or by clicking a mouse button. The “7” digit is at magnitude 100 within the value. The “7” digit within the first field has been highlighted and the “0” digit corresponding to magnitude 100 in the second associated field has been highlighted.

The user then moves the mouse down by one increment and right by one increment.

The third step 17 shows the value of the first field and the value of the second field as they have been changed. The original value of the first field, “2786”, has been increased by 100 to “2886”. In this example, the movement of the mouse along the X axis changes the value of the first field and movement to the right increases this value.

In this example, movement of the mouse along the Y axis changes the value of the second field and movement downwards decreases this value. The original value, “4012”, less 100 results in a new value of “3912”.

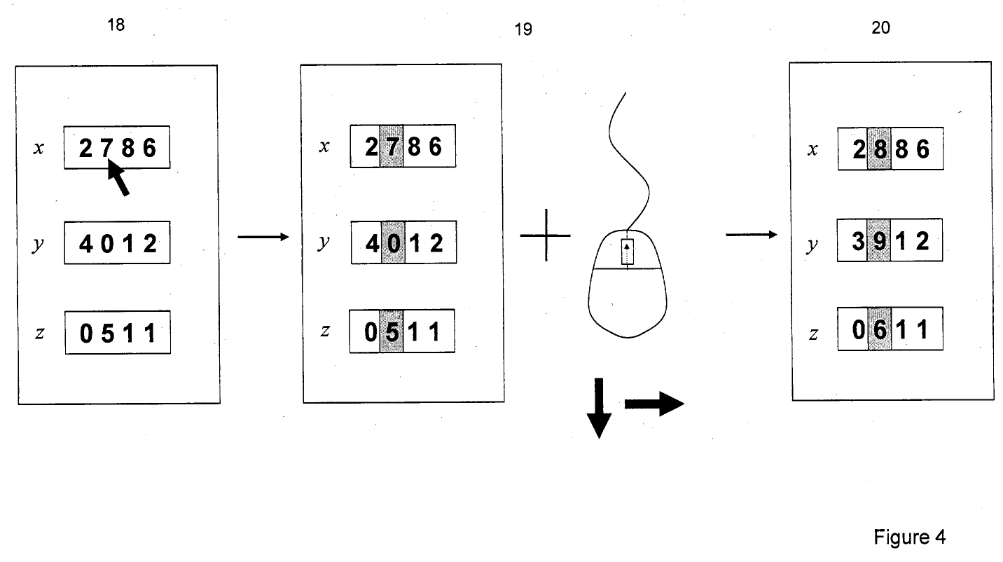

FIG. 4 illustrates an example where there are three associated fields. All of the fields are spatial co-ordinates and represent the three axes of a 3-D environment.

This example is similar to the example given in FIG. 3. In this example the third z axis field is controlled by the scroll wheel on the mouse.

The scroll wheel is moved forward by one increment in the second step 19. In this particular example movement of the scroll wheel forward increases the value of the field.

The value within the z axis field has changed in step 20 by increasing by 100—the magnitude of the selected digit.

It will be appreciated that there are mouse devices that exist with different mechanisms to control different axes of movement, such as mouse devices with two scroll wheels or built-in track-balls. It will be appreciated that such devices may increase the number of associated fields which may be controlled at one time.

In the examples given in FIGS. 3 and 4, the mouse device is being moved in all axes of movement. It will be appreciated that the mouse device may be moved only along one axis of movement. If the mouse device is moved along only one axis only the value within the field over which that axis of movement has control will change.

The method can be deployed on a standard personal computer with at least a processor, memory, a user input device, and an output device.

The present invention provides the advantage of coarse and fine control over a field. This advantage is beneficial for applications with fields with large ranges of values that are modified by user input. Such applications include three-dimensional modelling and animation software, where the fields can contain X and Y co-ordinates, or activation values. Activation values (including animation keyframes, which have a time value and an orthogonal value which is used to interpolate animation data between consecutive keyframes) are values which specify the activation conditions (including timing) for animation actions.

The present invention provides a simple user interface method and system to enable a user to change the value of a field, or the values of two or more associated fields, with a high degree of control and ease of use. The method and system is intuitive to users of pointer based graphical user interfaces and may be incorporated into existing applications with minimal or no alteration to existing visual components.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of controlling a field, the method including the steps of:
i. displaying a value from the field on a display device;
ii. selecting a digit of the value displayed in response to user input from a pointer device; and
iii. changing the value by the magnitude of the selected digit in response to user input from a pointer device.

2. A method as claimed in claim 1 wherein the value is numeric.

3. A method as claimed in claim 2 wherein movement of the pointer device right by one increment increases the value by the magnitude of the digit and wherein movement of the pointer device left by one increment decreases the value by the magnitude of the digit.

4. A method as claimed in claim 3 wherein the pointer device is a mouse.

5. A method as claimed in claim 4 wherein the digit is selected by moving a pointer using the mouse over the digit in the value and pressing a mouse button.

6. A method as claimed in claim 2 wherein movement of the pointer device up by one increment increases the value by the magnitude of the digit and wherein movement of the pointer device down by one increment decreases the value by the magnitude of the digit.

7. A method as claimed in claim 5 wherein the pointer device is a mouse.

8. A method as claimed in claim 7 wherein the digit is selected by moving a pointer using the mouse over the digit in the value and pressing a mouse button.

9. A method of controlling a first field and any number of associated fields, the method including the steps of:
i. displaying the value of the first field and values of the associated fields;
ii. selecting a digit of the value of the first field in response to user input from a pointer device; and
iii. changing the value of the first field and values of the associated fields by the magnitude of the digit selected in response to user input from a pointer device.

10. A method as claimed in claim 9 wherein the user input device is a pointer device.

11. A method as claimed in claim 10 wherein the pointer device is a mouse.

12. A method as claimed in claim 11 wherein the digit is selected by moving a pointer using the mouse over the digit in the value and pressing a mouse button.

13. A method as claimed in claim 12 wherein movement of the pointer device right by one increment increases the value of the first field by the magnitude of the digit and wherein movement of the pointer device left by one increment decreases the value of first field by the magnitude of the digit.

14. A method as claimed in claim 13 wherein movement of the pointer device up increases the value of an associated field by the magnitude of the digit and wherein movement of the pointer device down decreases the value of the associated field by the magnitude of the digit.

15. A method as claimed in claim 11 wherein an input means is provided for varying a third dimension.

16. A method as claimed in claim 15 wherein the input means is a scroll wheel on the mouse.

17. A method as claimed in claim 16 wherein movement of the scroll wheel forward by one increment increases the value of a second associated field by the magnitude of the digit and wherein movement of the scroll wheel backward by one increment decreases the value of the second associated field by the magnitude of the digit.

18. A user interface system as claimed in claim 17 wherein the first field represents an x axis value, the associated field represents a y axis value, and the second associated field represents a z axis value.

19. A user interface system for controlling a field, the system comprising:
i. a processor for changing a value in response to movement of a user input device;
ii. memory for storing the value;
iii. a user input device to select a digit of the value and to provide feedback to the processor to change to value; and
iv. an output device for displaying the value.

20. A user interface system as claimed in claim 19 wherein the user input device is a pointer device.

21. A user interface system as claimed in claim 20 wherein the pointer device is a mouse.

22. A user interface system as claimed in claim 21 wherein the digit is selected by moving a pointer using the mouse over the digit in the value and pressing a mouse button.

23. A user interface system as claimed in claim 22 wherein movement of the pointer device right by one increment increases the value by the magnitude of the digit and wherein movement of the pointer device left by one increment decreases the value by the magnitude of the digit.

24. A user interface system as claimed in claim 22 wherein movement of the pointer device up by one increment increases the value by the magnitude of the digit and wherein movement of the pointer device down by one increment decreases the value by the magnitude of the digit.

25. A user interface system for controlling a first field and any number of associated fields, the system comprising:
i. a processor for changing the value of the first field and values of the associated fields in response to movement of a user input device;
ii. memory for storing the values of the first and associated fields;
iii. a user input device to select a digit of the value of the first field and to provide feedback to the processor to change the values of the first and associated fields; and
iv. an output device for displaying values of the first and associated fields.

26. A user interface system as claimed in claim 25 wherein the user input device is a pointer device.

27. A user interface system as claimed in claim 26 wherein the pointer device is a mouse.

28. A user interface system as claimed in claim 27 wherein the digit is selected by moving a pointer using the mouse over the digit in the value and pressing a mouse button.

29. A user interface system as claimed in claim 28 wherein movement of the pointer device right by one increment increases the value of the first field by the magnitude of the digit and wherein movement of the pointer device left by one increment decreases the value of first field by the magnitude of the digit.

30. A user interface system as claimed in claim 29 wherein movement of the pointer device up increases the value of an associated field by the magnitude of the digit and wherein movement of the pointer device down decreases the value of the associated field by the magnitude of the digit.

31. A user interface system as claimed in claim 27 wherein an input means is provided for varying a third dimension.

32. A user interface system as claimed in claim 31 wherein the input means is a scroll wheel on the mouse.

33. A user interface system as claimed in claim 32 wherein movement of the scroll wheel forward by one increment increases the value of a second associated field by the magnitude of the digit and wherein movement of the scroll wheel backward by one increment decreases the value of the second associated field by the magnitude of the digit.

34. A user interface system as claimed in claim 33 wherein the first field represents an x axis value, the associated field represents a y axis value, and the second associated field represents a z axis value.

35. A computer system for effecting the method of claim 1.

36. Software for effecting the method of claim 1.

37. Software for effecting the method of claim 4.

38. Software for effecting the method of claim 9.

39. Software for effecting the method of claim 13.

40. Storage media containing software as claimed in claim 36.

41. Storage media containing software as claimed in claim 38.
